(19) United States
(12) Patent Application Publication
(10) Pub. No.: US 2024/0397295 A1
(43) Pub. Date: Nov. 28, 2024

(54) MULTIMODE VEHICLE MESSAGING

(71) Applicant: GM GLOBAL TECHNOLOGY OPERATIONS LLC, Detroit, MI (US)

(72) Inventors: Venkata Naga Siva Vikas Vemuri, Farmington Hills, MI (US); Scott T. Droste, West Bloomfield, MI (US); Rajas M. Sevekari, Macomb, MI (US); Charles A. Everhart, Canton, MI (US)

(73) Assignee: GM GLOBAL TECHNOLOGY OPERATIONS LLC, Detroit, MI (US)

(21) Appl. No.: 18/324,378

(22) Filed: May 26, 2023

(51) Int. Cl. H04W 4/44; H04L 67/561

(52) U.S. Cl. CPC H04W 4/44; H04L 67/561

(57) ABSTRACT

Multimode messaging of the type suitable for use in communicating a plurality of datasets to a vehicle, a telematics unit, and/or another device. The multimode message may be facilitated with a hybrid platform having a plurality of radio access points configured for supporting messaging with a vehicle according to differing types of wireless radio communications and a back office controller configured for determining multimode information to be added to each of the datasets prior to the datasets being communicated to the hybrid platform for transport to the vehicle.

### INTRODUCTION

The present disclosure relates to multimode vehicle messaging, such as but not necessarily limited to multimode messaging of the type suitable for use in communicating a plurality of datasets to a vehicle or other device via a plurality of radio access points operating at a hybrid platform.

More and more vehicles may include capabilities for supporting an ever expanding range of services, with the operation of the services, at least in some non-limiting circumstances, being dependent on various modes of wireless messaging, or what may be referred to more simply as multimode messaging. To support the services, and optionally other wireless communication based operations, some vehicles may include a telematics unit or other hardware capable of supporting multimode messaging across disparate radio networks, i.e., capabilities to support differing modes of messaging across differing types of radio networks. While the vehicles may include such capabilities to support multimode messaging, one non-limiting aspect of the present disclosure contemplates a need to manage operation of the disparate radio networks when supporting multimode messaging. In the past, an originator of a message or other dataset intended for wireless communication to a vehicle would be responsible for selecting the radio network to be used in the communication thereof, with the selected radio network thereafter being responsible for supporting transmission of the corresponding messaging.

Such dependence of the message originator and/or the radio network may undesirably limit original equipment manufacturers (OEMs) and/or other entities having an interest in overseeing operation of the vehicles and/or the services. This historic inability to provide backend support or upstream management may thwart those having a vested interest in the vehicle and/or the services from maintaining or having oversight, assuring customer satisfaction, and/or otherwise being involved or participatory in the wireless delivery of multimode messaging that may affect their value to customers and performance of the vehicle and/or the services.

### SUMMARY

One non-limiting aspect of the present disclosure relates to improving management of multimode messaging, optionally through testing or virtualization tools capable of simulating functionality behavior of disparate radio networks and/or a hybrid platform configured for providing control, protection, feedback and/or other management capabilities for maximizing throughput, quality of service, etc.

One non-limiting aspect of the present disclosure relates to a system for multimode vehicle messaging. The system may include a hybrid platform having a plurality of radio access points configured for supporting multimode messaging with a vehicle according to differing types of wireless radio communications, with each of the radio access points supporting communications over a corresponding radio network. The system may further include a back office controller configured for receiving a plurality of datasets from an application, with each dataset being commonly addressed for wireless communication to a vehicle. The back office controller may be configured for determining operating characteristics for the plurality of radio networks, determining multimode information for each of the datasets based on the operating characteristics, and adding the multimode information to each of the datasets prior to relaying the datasets to the hybrid platform, the multimode information specifying synchronization and routing information to be used at the hybrid platform in identifying and controlling a corresponding one of the radio access points to wirelessly communicate the corresponding one of the datasets to the vehicle. The system may further include a telematics unit configured for use onboard the vehicle to wirelessly receive the datasets over each one of the radio networks operating with the hybrid platform.

The multimode information may include a data code for each of the datasets for specifying one or more processing schemes to be employed at the radio access point when communicating the corresponding dataset.

The multimode information may include a packet identifier for each of the datasets for specifying fragmentation details for the corresponding dataset.

The multimode information may include a network code for each of the datasets for specifying a type of modulation to communicate the corresponding dataset.

The system may include at least one of the radio access points being an Internet of Things (IoT) message broker controller, a Wi-Fi message controller, and/or a cellular controller.

The back office controller may be configured to determine the operating characteristics from a simulation generated for the hybrid platform. The simulation may set representational behaviors to simulate functionality and behavior for the radio networks.

The back office controller may be configured to determine the operating characteristics from network performance measurements generated from monitoring performance of the radio networks when communicating additional datasets to additional vehicles.

The back office controller may be configured for selecting the network code for each of the datasets based on one or more of a cost, a time sensitivity, a data rate, and a quality of service associated with the corresponding dataset.

One non-limiting aspect of the present disclosure relates to a system for multimode vehicle messaging. The system may include a hybrid platform having an Internet of Things (IoT) message broker controller configured for communicating IoT messages over an IoT network, a Wi-Fi message controller configured for communicating Wi-Fi messages over a Wi-Fi network, and a cellular controller configured for communicating cellular messages over a cellular network. The system may further include a back office controller configured for receiving a plurality of datasets from an application, with each dataset being commonly addressed for wireless communication to a vehicle. The back office controller may be configured for determining operating characteristics for the IoT, Wi-Fi, and cellular networks, determining multimode information for each of the datasets based on the operating characteristics, and associating the multimode information with each of the datasets prior to relaying the datasets to the hybrid platform. The multimode information may specify synchronization and routing information to be used at the hybrid platform in identifying and controlling a corresponding one of the IoT message broker controller, Wi-Fi message controller, and cellular controller to communicate the corresponding one of the datasets to the vehicle.

The system may include a telematics unit configured for use onboard the vehicle to wirelessly receive the datasets over each one of the IoT, Wi-Fi, and cellular networks operating at the hybrid platform.

The multimode information for each of the datasets may include a scheme code specifying one or more processing schemes to be employed at the radio access point when communicating the corresponding dataset, a packet identifier for specifying fragmentation details for the corresponding dataset, and an access point code for specifying one of the IoT message broker controller, Wi-Fi message controller, and cellular controller to communicate the corresponding dataset.

The back office controller may be configured for selecting one of the IoT message broker controller, Wi-Fi message controller, and cellular controller to be used in communicating each of the datasets based on one or more of a cost, a time sensitivity, a data rate, and a quality of service associated therewith.

The back office controller may be configured to determine the operating characteristics from a simulation generated for the hybrid platform, with the simulation setting representational behaviors to simulate functionality and behavior for the radio networks.

The back office controller may be configured to determine the operating characteristics from network performance measurements generated from monitoring performance of the radio networks when communicating additional datasets to additional vehicles.

One non-limiting aspect of the present disclosure relates to a method for multimode vehicle messaging. The method may include identifying a plurality of datasets transmitted from an application for wireless communication to a vehicle and determining operating characteristics for a hybrid platform having an Internet of Things (IoT) message broker controller configured for communicating IoT messages over an IoT network, a Wi-Fi message controller configured for communicating Wi-Fi messages over a Wi-Fi network, and a cellular controller configured for communicating cellular messages over a cellular network. The method may further include determining multimode information to be associated with each of the datasets prior to the datasets being communicated to the hybrid platform for communication to the vehicle. The multimode information may specify synchronization and routing information to be used at the hybrid platform in instructing a corresponding one of the IoT message broker controller, Wi-Fi message controller, and cellular controller to communicate the corresponding one of the datasets to the vehicle.

The method may include determining the operating characteristics from a simulation generated for the hybrid platform. The simulation may set representational behaviors to simulate functionality and behavior for the radio networks.

The method may include determining the operating characteristics from network performance measurements generated from monitoring performance of the radio networks when communicating additional datasets to additional vehicles.

These features and advantages, along with other features and advantages of the present teachings, are readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a system for multimode messaging in accordance with one non-limiting aspect of the present disclosure.

FIG. 2 illustrates a diagram of a method for multimode vehicle messaging in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

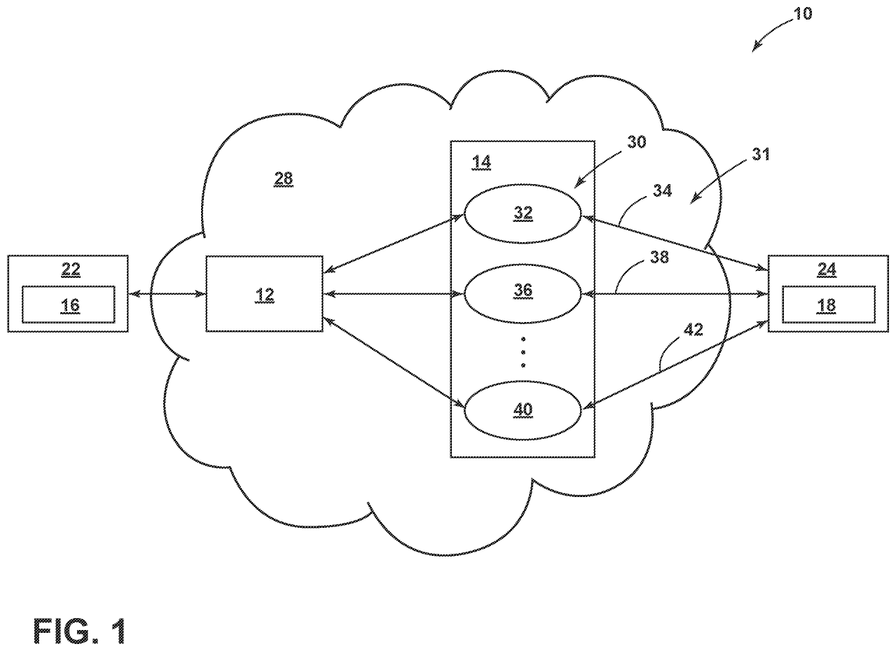

FIG. 1 illustrates a system 10 for multimode messaging in accordance with one non-limiting aspect of the present disclosure. The system 10 may include a back office controller 12 configured for operating with a hybrid platform 14 to facilitate multimode message exchange between an application 16, a telematics unit 18, and/or additional entities, devices, etc. The system 10 is predominantly described with respect to the application 16 operating on a mobile device 22, phone, computer, etc. and the telematics unit 18 operating onboard a vehicle 24, such as but not necessarily limited to an automobile. The system 10 is described in this manner for exemplary and non-limiting purpose to highlight advantageous capabilities of the present disclosure to support a multimode messaging environment whereby customer facing endpoints, i.e., the application 16 and the telematics unit 18, may benefit from backend support or upstream management, testing, etc. The back office controller 12 and/or the hybrid platform 14, which may reside on separate or common infrastructures, such as a server or virtual platform, may be included as part of a private network 28. The private network 28 may be configured for providing oversight, assuring customer satisfaction, and/or otherwise being involved or participatory in the wireless delivery of multimode messaging that may affect performance of the vehicle 24 and/or the services thereat. The present disclosure, however, is not intended to be so limited as one having ordinary skill in the art would readily appreciate the advantageous capabilities of the system 10 to support multimode messaging for other types of endpoints.

The application 16 and/or the telematics unit 18 may be configured to exchange information, data, etc. with each other via the hybrid platform 14, which may be generically referred to as datasets. One non-limiting aspect of the present disclosure contemplates the application 16 being configured for remotely supporting, directing, controlling, or otherwise influencing services, capabilities, operations, etc. onboard the vehicle 24 via exchange of the datasets with the telematics unit 18. This may be accomplished by the application 16 generating the datasets to include instructions, data, files, media, etc. for transmission to the vehicle 24, and in some cases responsively receiving datasets from the telematics unit 18. The datasets, for example, may be used to remotely unlock the vehicle 24, start an engine or other system 10 onboard the vehicle 24, e.g., a heating and/or cooling system 10, perform diagnostics, e.g., requests battery stated charge, fuel levels, etc., and/or to facilitate a wide range of other services for the vehicle 24. One non-limiting aspect of the present disclosure contemplates configuring the back office controller 12 and the hybrid platform 14 having a plurality of radio access points 30 to manage transport of datasets between the application 16 and the telematics unit 18 over corresponding radio networks 31. This capability to provide backend support or upstream management of dataset communications may be advantageous in enabling those having a vested interest in operation of the vehicle 24 and/or the services to control dataset communications across optionally differing types of wireless radio communications associated with the radio access points.

The hybrid platform 14 is shown for non-limiting purposes with at least a portion of the radio access points 30 being disparately configured for providing an Internet of Things (IoT) message broker controller 32 configured for communicating IoT messages over an IoT network 34, a Wi-Fi message controller 36 configured for communicating Wi-Fi messages over a Wi-Fi network 38, and a cellular controller 40 configured for communicating cellular messages over a cellular network 42. The IoT message broker controller 32 may be responsible for message handling and routing within the IoT network 34, such as by acting as a centralized communication hub that receives messages from various IoT devices, sensors, or applications and routes them to the appropriate destinations. The message broker controller 32 may enable decoupling of communication between different components by following a publish/subscribe model. The Wi-fi controller 36 may be specific to managing the Wi-Fi network 38, such as in environments where Wi-Fi connectivity may be available, and may be configured for overseeing the configuration, management, and optimization of Wi-Fi access points (APs) within a network. It may handle tasks such as AP provisioning, channel assignment, security settings, and client device authentication. The cellular controller 40 may be responsible for managing cellular communication within the cellular network 42, such as by serving as a central point that coordinates communication between cellular devices and the cellular network infrastructure.

The hybrid platform 14 may be configured in this manner to support multimode messaging with the telematics unit 18 using the IoT broker, Wi-Fi, and/or cellular controllers 32, 36, 40 and corresponding IoT, Wi-Fi, and/or cellular messages. The multimode messaging may be characterized in this manner to correspond with capabilities of the hybrid platform 14 to facilitate exchanging messages with the telematics unit 18 according to differing modes of messaging associated with each of the radio access points and the corresponding radio networks. This multimode capability may be beneficial in supporting an ever expanding range of services being made available onboard the vehicle 24, such as to support the services, at least in some non-limiting circumstances, that may be dependent on various modes of wireless messaging, or what may be referred to more simply as multimode messaging. To maximize support of the services, and optionally other wireless communication based operations, the telematics unit 18, or other similar hardware onboard the vehicle 24, may be configured for supporting the multimode messaging across each of the disparate radio networks 31, i.e., capabilities to support differing modes of messaging across differing types of radio networks 31.

One non-limiting aspect of the present disclosure relates to configuring the back office controller 12 to oversee multimode messaging related activities of the hybrid platform 14. The back office controller 12, for example, may be configured to receive a plurality of datasets from the application 16 and thereafter control delivery of the datasets to the telematics unit 18 using multimode messaging dispersed across the radio access points. The back office controller 12 may be configured for determining operating characteristics for the radio networks 31 associated with the radio access points 30, and based thereon, to controllably partition the datasets for communication according to selectable design parameters. The back office controller 12, relatedly, may be configured for assessing a throughput, a cost, a time sensitivity, a data rate, a quality of service, and/or additional metrics, and based thereon, to partition the datasets for delivery across one or more of the radio access points 30. FIG. 1 illustrates a non-limiting example whereby the back office controller 12 may receive a plurality of datasets from the application 16 and thereafter parse the datasets for delivery using each of the IoT, Wi-Fi, and cellular messages, i.e., such that a least a portion of the datasets are communicated through each of the IoT broker, Wi-Fi, and cellular controllers 32, 36, 40 for corresponding exchange over the related IoT broker, Wi-Fi, and cellular networks 34, 38, 42.

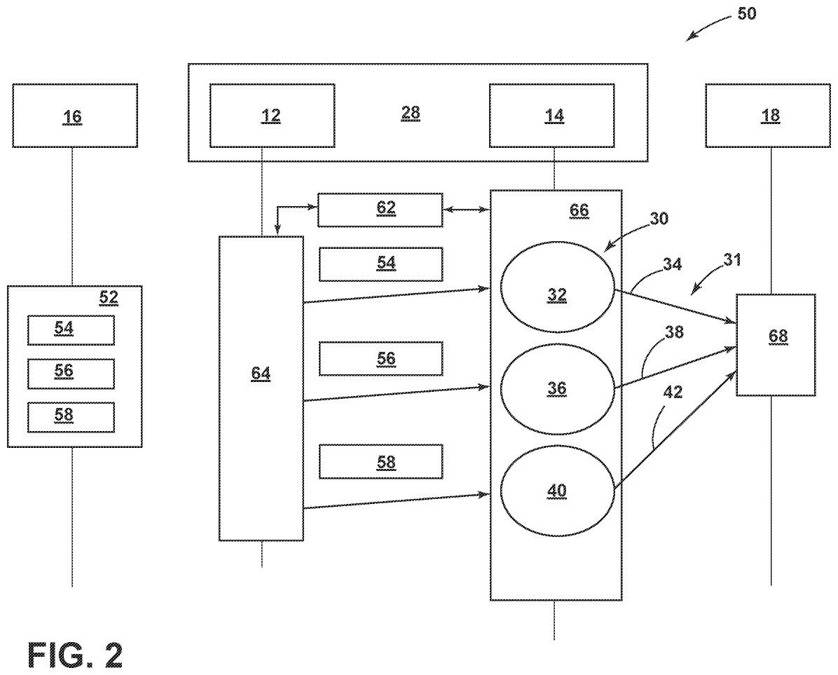

FIG. 2 illustrates a diagram 50 of a method for multimode vehicle 24 messaging in accordance with one non-limiting aspect of the present disclosure. Block 52 relates to a generation process whereby the application 16 may generate a plurality of datasets 54, 56, 58 for multimode message transmission to the telematics unit 18. The generation process is illustrated for non-limiting purposes to correspond with the application 16 generating the plurality of datasets 54, 56, 58, which may be referred to as a first dataset 54, a second dataset 56, and a third dataset 58. The application 16 or other entity originating datasets may generate the datasets simultaneously, successively, or according to other sequencing. The datasets 54, 56, 58 may be commonly addressed to the vehicle 24 and initially transmitted from the application 16 to the private network 28. The datasets 54, 56, 58 may be utilized, for example, to facilitate over the air (OTA) reflash, vehicle 24 unlock, and/or to provide information or controls used to manipulate additional services other services and/or features onboard the vehicle 24. The generation process may be instigated according to user manipulation of the application 16 or the features of available on the mobile device 22. While the generation process is shown to originate the datasets 54, 56, 58 from a device offboard of the vehicle 24, the present disclosure fully contemplates the datasets 54, 56, 58 originating from other locations or entities, including from sources onboard or included as part of the vehicle 24.

Block 62 relates to a management process whereby the back office controller 12 or other entity associated with the private network 28 may be configured for predicting, monitoring, controlling or otherwise managing operations for the hybrid platform 14. One non-limiting aspect of the present disclosure contemplates the management process including a feedback process whereby the back office controller 12 may monitor or otherwise assess network performance of the hybrid platform 14, such as by monitoring network performance measurements and/or metrics reflective operating characteristics for the radio access points 30 and/or the corresponding radio networks 31. The operating characteristics may be used for reflecting throughput, latency, modulation requirements or capabilities, processing schemes, and other parameters associated with communicating messaging over the radio networks 31, i.e., requirements for modulating, packaging, formatting, etc. each of the IoT, Wi-Fi, and cellular messages. The management process may include exchanging information between the back office controller 12 and/the hybrid platform 14 to assess the operations thereof and/or to exchange control parameters used to control the operations thereof. The management process, as such, may relate to various operations contemplated by the present disclosure to support multimode vehicle 24 messaging.

One non-limiting be aspect of the present disclosure contemplates determining the operating characteristics from actively monitoring operations of the radio networks 31, such as based on statistics gathered from monitoring transmission of additional datasets 54, 56, 58 or multimode messaging previously transmitted to the vehicle 24 and/or to other vehicle 24s (not shown), i.e., monitoring historical performance of the hybrid platform 14. This type of monitoring may be considered as real-time monitoring or actual monitoring generated based on actual performance of the radio networks 31 when constructed in a real-life or real-world deployment where the corresponding multimode messaging may travel over long distances from the hybrid platform 14 to the telematics unit 18. In such an implementation, for example, the radio access points 30 may be in the control of the private network 28, with the attendant radio networks 31 being in the control of a supplier entity that previously constructed switches, headends, enodes, terminals, towers, stations, etc. within the real word, i.e., a deployed infrastructure constructed by a utility company, Wi-Fi and/or cellular provider, or other multiple service provider.

One non-limiting aspect of the present disclosure contemplates an additional manner for determining the operating characteristics based on a simulation for the radio networks 31. The simulation may be performed to set representational behaviors intended to simulate functionality behavior sufficient for controlling the hybrid platform 14, the radio access points 30, and/or the radio networks 31 to provide a virtualized tool capable of modeling an actual implementation of the radio networks 31 without the radio networks 31 having to be actually deployed with infrastructure within the real world. The simulation, for example, may be implemented with a network tool (not shown) having hardware and software constructs configured for simulating communications between the radio access points 30 and the vehicle 24. The simulation, in other words, may be used to provide a testing of environment where multimode messaging may be communicated with the vehicle 24 without the corresponding multimode messaging traveling over actual, real-world deployed infrastructures. The corresponding multimode messaging may be wirelessly transmitted to the vehicle 24, such as with short-range wireless signaling carried without the underlying infrastructure and longer-range transmission that would otherwise be needed for deployed radio networks.

Accordingly, the private network 28, or more specifically the hybrid platform 14 and the radio access points 30, may be configured to support multimode messaging over deployed radio networks and/or simulated radio networks. For the sake of presentation simplicity, the description herein is predominantly addressed towards the radio networks 31 being deployed such that the multimode messaging carried thereover may be exchanged with the corresponding radio access points 30 to travel over deployed infrastructures, i.e. across wired backbones, towers, cables, etc. whereafter the multimodal messages may be wirelessly exchanged with the vehicle 24. Block 64 relates to the multimode process whereby the back office controller 12 may generate multimode information for the datasets 54, 56, 58 based on the operating characteristics determined in Block 62. The multimode information may be generated for specifying synchronization and routing information to be used at the hybrid platform 14 in identifying and controlling each of the radio access points 30 to wirelessly communicate one or more of the datasets 54, 56, 58. FIG. 2 illustrates a non-limiting example whereby the IoT broker controller 32 may be instructed to transport the first dataset within one or more IoT messages, the Wi-fi controller 36 may be instructed to transport the second dataset within one or more Wi-Fi messages, and the cellular controller may be configured to transport the third dataset within one or more cellular messages.

The multimode process may include the back office controller 12 adding or otherwise associating the multimode information with each of the corresponding datasets 54, 56, 58. One non-limiting aspect of the present disclosure contemplates the back office controller 12 generating the multimode information to include a data or scheme code for specifying one or more processing schemes to be employed at the radio access point when communicating the corresponding dataset, a packet identifier for specifying fragmentation details for the corresponding dataset, and a network or access point code for specifying one of the IoT message broker controller 32, Wi-Fi message controller, and cellular controller to be employed at the radio access point when communicating the corresponding dataset. The back office controller 12 may be configured for selecting the network code for each of the datasets 54, 56, 58 based on one or more of a cost, a time sensitivity, a data rate, and a quality of service associated with the corresponding dataset.

The multimode process may generally correspond with the back office controller 12 determining operating characteristics for the radio networks 31, generating corresponding multimode information, and associating with the multimode information with the datasets 54, 56, 58 to facilitate transmission over the radio networks 31, i.e., to provide the multimode information in a manner suitable for use with the IoT message broker, Wi-Fi, and/or cellular controllers 32, 36, 40 to correspondingly transmit the datasets 54, 56, 58 using multimode vehicle 24 messaging, i.e., IoT, Wi-Fi, and/or cellular messages. Block 66 relates to retransmission process whereby the hybrid platform 14 may receive the datasets 54, 56, 58 and attended multi-information, and based thereon, control the corresponding radio access points 30 transmit corresponding multimode messages over the radio networks 31. Block 68 may relate to the telematics unit 18 processing the tunnel messaging for use in attracting operation of services onboard the vehicle 24 or otherwise associated therewith.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All values of parameters (e.g., of quantities or conditions), unless otherwise indicated expressly or clearly in view of the context, including the appended claims, are to be understood as being modified in all instances by the term “about” whether or not “about” actually appears before the value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A system for multimode vehicle messaging, comprising:
a hybrid platform having a plurality of radio access points configured for supporting multimode messaging with a vehicle according to differing types of wireless radio communications, each of the radio access points supporting communications over a corresponding radio network;
a back office controller configured for receiving a plurality of datasets from an application, each dataset being commonly addressed for wireless communication to a vehicle, the back office controller configured for:
determining operating characteristics for the radio networks;
determining multimode information for each of the datasets based on the operating characteristics; and
adding the multimode information to each of the datasets prior to relaying the datasets to the hybrid platform, the multimode information specifying synchronization and routing information to be used at the hybrid platform in identifying and controlling a corresponding one of the radio access points to wirelessly communicate the corresponding one of the datasets to the vehicle; and
a telematics unit configured for use onboard the vehicle to wirelessly receive the datasets over each one of the radio networks operating with the hybrid platform.

2. The system according to claim 1, wherein:
the multimode information includes a data code for each of the datasets, the data code specifying one or more processing schemes to be employed at the corresponding radio access point when communicating the corresponding dataset.

3. The system according to claim 1, wherein:
the multimode information includes a packet identifier for each of the datasets, the packet specifying fragmentation details for the corresponding dataset.

4. The system according to claim 1, wherein:
the multimode information includes a network code for each of the datasets, the network code specifying a type of modulation to communicate the corresponding dataset.

5. The system according to claim 1, wherein:
at least one of the radio access points is an Internet of Things (IoT) message broker controller.

6. The system according to claim 1, wherein:
at least one of the radio access points is a Wi-Fi message controller.

7. The system according to claim 1, wherein:
at least one of the radio access points is a cellular controller.

8. The system according to claim 1, wherein:
the back office controller is configured to determine the operating characteristics from a simulation generated for the hybrid platform, the simulation defining representational behaviors to simulate functionality and behavior for the radio networks.

9. The system according to claim 1, wherein:
the back office controller is configured to determine the operating characteristics from network performance measurements generated from monitoring performance of the radio networks when communicating additional datasets to additional vehicles.

10. The system according to claim 1, wherein:
the radio access points include:
an Internet of Things (IoT) message broker controller;
a Wi-Fi message controller; and
a cellular controller; and
the multimode information for each of the datasets includes:
a data code specifying one or more processing schemes to be employed at the radio access point when communicating the corresponding dataset;
a packet identifier for specifying fragmentation details for the corresponding dataset; and
a network code for specifying one of the IoT message broker controller, Wi-Fi message controller, and cellular controller to be employed at the radio access point when communicating the corresponding dataset.

11. The system according to claim 10, wherein:
the back office controller is configured for selecting the network code for each of the datasets based on one or more of a cost, a time sensitivity, a data rate, and a quality of service associated with the corresponding dataset.

12. A system for multimode vehicle messaging, comprising:
a hybrid platform having an Internet of Things (IoT) message broker controller configured for communicating IoT messages over an IoT network, a Wi-Fi message controller configured for communicating Wi-Fi messages over a Wi-Fi network, and a cellular controller configured for communicating cellular messages over a cellular network; and
a back office controller configured for receiving a plurality of datasets from an application, each dataset being commonly addressed for wireless communication to a vehicle, the back office controller configured for:
determining operating characteristics for the IoT, Wi-Fi, and cellular networks;
determining multimode information for each of the datasets based on the operating characteristics; and
associating the multimode information with each of the datasets prior to relaying the datasets to the hybrid platform, the multimode information specifying synchronization and routing information to be used at the hybrid platform in identifying and controlling a corresponding one of the IoT message broker controller, Wi-Fi message controller, and cellular controller to communicate the corresponding one of the datasets to the vehicle.

13. The system according to claim 12, further comprising:
a telematics unit configured for use onboard the vehicle to wirelessly receive the datasets over each one of the IoT, Wi-Fi, and cellular networks operating at the hybrid platform.

14. The system according to claim 13, wherein:
the multimode information for each of the datasets includes:
a scheme code specifying one or more processing schemes to be employed at the corresponding radio access point when communicating the corresponding dataset;
a packet identifier for specifying fragmentation details for the corresponding dataset; and
an access point code for specifying one of the IoT message broker controller, Wi-Fi message controller, and cellular controller to communicate the corresponding dataset.

15. The system according to claim 13, wherein:
the back office controller is configured for selecting one of the IoT message broker controller, Wi-Fi message controller, and cellular controller to be used in communicating each of the datasets based on one or more of a cost, a time sensitivity, a data rate, and a quality of service associated therewith.

16. The system according to claim 15, wherein:
the back office controller is configured to determine the operating characteristics from a simulation generated for the hybrid platform, the simulation setting representational behaviors to simulate functionality and behavior for the IoT, Wi-Fi, and cellular networks.

17. The system according to claim 15 wherein:
the back office controller is configured to determine the operating characteristics from network performance measurements generated from monitoring performance of the IoT, Wi-Fi, and cellular networks when communicating additional datasets to additional vehicles.

18. A method for multimode vehicle messaging, comprising:
identifying a plurality of datasets transmitted from an application for wireless communication to a vehicle;
determining operating characteristics for a hybrid platform having an Internet of Things (IoT) message broker controller configured for communicating IoT messages over an IoT network, a Wi-Fi message controller configured for communicating Wi-Fi messages over a Wi-Fi network, and a cellular controller configured for communicating cellular messages over a cellular network;
determining multimode information to be associated with each of the datasets prior to the datasets being communicated to the hybrid platform for communication to the vehicle, the multimode information specifying synchronization and routing information to be used at the hybrid platform in instructing a corresponding one of the IoT message broker controller, Wi-Fi message controller, and cellular controller to communicate the corresponding one of the datasets to the vehicle.

19. The method according to claim 18, further comprising:
determining the operating characteristics from a simulation generated for the hybrid platform, the simulation setting representational behaviors to simulate functionality and behavior for the IoT, Wi-Fi, and cellular networks.

20. The method according to claim 18, wherein:
determining the operating characteristics from network performance measurements generated from monitoring performance of the IoT, Wi-Fi, and cellular networks when communicating additional datasets to additional vehicles.
